(19) United States
(12) Patent Application Publication
(10) Pub. No.: US 2025/0304268 A1
(43) Pub. Date: Oct. 2, 2025

(54) DEPLOYABLE DATA RECORDER SYSTEMS FOR AIRCRAFT

(71) Applicant: THE BOEING COMPANY, Arlington, VA (US)

(72) Inventors: William Anderson, Salt Lake City, UT (US); Cole Sheyka, Santa Ana, CA (US); James Andrew Cadagan, San Carlos, CA (US); Luke Carey, Upton, MA (US); Madelene Hays McNary, Elizabeth, CO (US); Trevor Ryan Groves, Eugene, OR (US); Maxwell Patwardhan, Boulder, CO (US); Charles Brewster Beck von Peccoz, Wellesley, MA (US); Swagatam Das, Atlanta, GA (US)

(21) Appl. No.: 18/507,535

(22) Filed: Nov. 13, 2023

(51) Int. Cl. B64D 25/20; B64D 45/00; G07C 5/08

(52) U.S. Cl. CPC B64D 25/20; B64D 45/00; G07C 5/0858; B64D 2045/0065

(57) ABSTRACT

An apparatus includes a body. The body includes an electronics chamber and an inflation chamber. The apparatus further includes a pressure sensor coupled to the body. The apparatus further includes a plurality of connector assemblies coupled to the inflation chamber. The apparatus further includes inflatable bags, where each inflatable bag is coupled to an individual connector assembly of the plurality of connector assemblies. The apparatus further includes a transmitter located within the electronics chamber. The apparatus further includes a processor located within the electronics chamber and coupled to a memory device. The processor is configured to detect submersion of the body in water, send a signal to cause initiation of a reaction in the inflation chamber, and cause the transmitter to send a data transmission.

### FIELD OF THE DISCLOSURE

The present disclosure is generally related to deployable data recorder systems for aircraft.

### BACKGROUND

A flight recorder is an electronic recording device placed in an aircraft to record information for the purpose of facilitating the investigation of aviation accidents and incidents. A flight data recorder, a cockpit voice recorder, or a combination thereof, are examples of flight recorders. A flight data recorder may be employed to record data sent to and received from various electronic systems on the aircraft. A cockpit voice recorder may record conversation and other sounds in the aircraft cockpit, as well as radio communication between personnel in the cockpit and others. Flight recorders are designed to resist severe conditions (e.g., impact, high temperature, water exposure) so that data stored by the flight recorders can be analyzed.

A particular type of flight recorder is configured to deploy from an aircraft when the aircraft is located at a shallow depth in a body of water (e.g., an ocean) to facilitate recovery of the flight recorder. Deployment of the flight recorder causes the flight recorder to separate from the aircraft and float on a surface of the body of water. Some deployable flight recorders can be subject to damage when deployed that can cause the flight recorder to sink or be difficult to visibly locate, can be difficult to maintain in operational condition, or combinations thereof. Accordingly, there is a need for a deployable flight recorder that is easy to maintain, that automatically deploys, remains afloat, does not fail due to water damage, and is visible from a distance when deployed.

### SUMMARY

In a particular implementation, a device includes a body. The body has an electronics chamber and an inflation chamber. The device includes a pressure sensor coupled to the body, a plurality of connector assemblies coupled to the inflation chamber, and inflatable bags. Each inflatable bag is coupled to an individual connector assembly of the plurality of connector assemblies. The device includes a transmitter located within the electronics chamber. The device also includes a processor located within the electronics chamber and coupled to a memory device. The processor is configured to: detect submersion of the body in water, send a signal to cause initiation of a reaction in the inflation chamber, and cause the transmitter to send a data transmission.

In another particular implementation, a system includes a plurality of deployable data recorder systems on an aircraft. Each deployable data recorder system is located at a different location on the aircraft. Each deployable data recorder system includes a body that has an electronics chamber and an inflation chamber, a pressure sensor coupled to the body, a plurality of connector assemblies coupled to the inflation chamber, and a plurality of inflatable bags. Each inflatable bag is coupled to an individual connector assembly of the plurality of connector assemblies. Each deployable data recorder system includes a transmitter located within the electronics chamber and a processor located within the electronics chamber and coupled to a memory device. The processor is configured to detect submersion of the body in water, send a signal to cause initiation of a reaction in the inflation chamber to generate gas to cause inflation of the inflatable bags, and cause the transmitter to send a data transmission.

In another particular implementation, a method of use of a deployable data recorder includes receiving, at a processor in an electronics chamber of the deployable data recorder, flight data associated with an aircraft via a releasable connector. The method includes sending, from the processor in response to detection of a submersion of the deployable data recorder in water below a threshold depth, an initiation signal to one or more reactants in an inflation chamber to cause generation of a gas to cause inflation of inflatable bags of the deployable data recorder. The method also includes causing, via the processor, transmission of a data transmission via a transmitter in the deployable data recorder.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a side view of an aircraft showing locations for deployable data recorders and a particular implementation of a deployable data recorder.

FIG. 2 is a cross-sectional, block diagram representation of a body of a deployable data recorder according to some implementations.

FIG. 3 is a particular implementation that illustrates the deployable data recorder and one or more components included with the deployable data recorder.

FIG. 4 is a diagram that illustrates a top plate of the deployable data recorder.

FIG. 5 is a flow chart of a method of use of a deployable data recorder.

FIG. 6 is a diagram of electronic components of a deployable data recorder.

### DETAILED DESCRIPTION

Aspects disclosed herein present systems, apparatus, and methods for a deployable data recorder. Prior to being deployed, the deployable data recorder is in a compartment of an aircraft in a stored configuration with rolled up inflatable bags and a releasable connector releasably coupled to a data connection of the aircraft to receive flight data. When the airplane is located in water (e.g., an ocean), the compartment fills with water, and water pressure causes the deployable data recorder to deploy when the depth of the data recorder is submerged below a threshold depth. Deployment of the deployable data recorder includes causing inflation of the inflatable bags to cause release of the deployable data recorder from the compartment and separation of the releasable connector from the data connection. Release of the deployable data recorder from the compartment allows the deployable data recorder to rise to a surface of the body of water.

The deployable data recorder includes a body and inflatable bags connected to the body. The deployable data recorder upon detecting, via a pressure sensor, that the body is at or below the threshold depth in water, sends a signal to cause initiation of a reaction in an inflation chamber to inflate the inflatable bags. Each of the inflatable bags are coupled to the body via a connector assembly that may include a combination of valves, threaded members, and rubber gaskets. The inflatable bags are configured to aid in the flotation of the body and be of a vibrant color to facilitate visual detection of the deployable data recorder in the water.

The body is configured to have at least two chambers. The chambers can include an electronics chamber that includes one or more electronic components and the inflation chamber that generates a gas to inflate the inflatable bags. The body is configured to have a positive buoyancy configured to enable floatation of the body even when one or more of the inflatable bags deflate or are filled with water. The electronics chamber includes a transmitter that sends a data transmission when the deployable data recorder is deployed. The electronics chamber is also configured to be water resistant.

By using the techniques and systems described herein, the deployable data recorder has the technical advantages of staying afloat even when one or more of the inflatable bags fails or fills with water, having an electronics chamber that is water resistant to protect the flight data, and being easy to visually detect from afar based on the inflatable bags having a vibrant color. The inflatable bags are coupled to the body by connector assemblies. Periodic replacement of the inflatable bags may be required to reduce a chance of one or more of the inflatable bags failing due to degradation of the inflatable bags or other causes. Another technical advantage of the deployable data recorder is that a connector assembly allows an inflatable bag to be removed from the body without a need to rotate the body or the inflatable bag, which may be advantageous in the limited available working area associated with the compartments where the deployable data recorders are stored. Another technical advantage of the deployable data recorder is that the power supply (e.g., lithium-ion battery) is replaceable.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

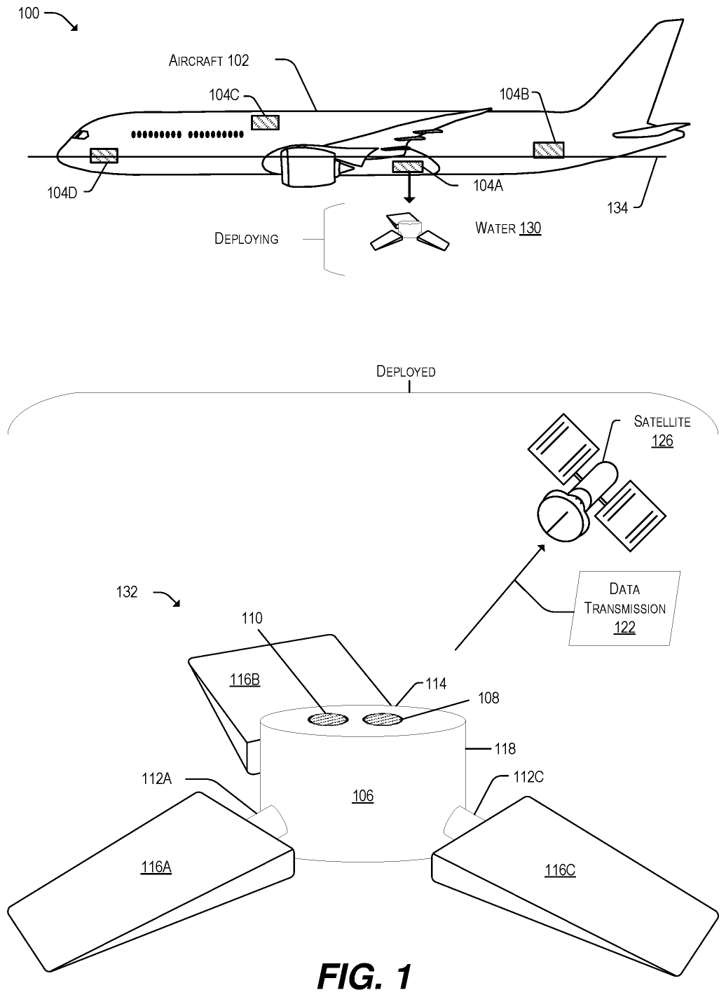

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple deployable data recorder systems 104 are illustrated and associated with reference numbers 104A. 104B. 104C, and 104D. When referring to a particular one of these deployable data recorder systems, such as the deployable data recorder system 104A, the distinguishing letter “A” is used. However, when referring to any arbitrary one of these deployable data recorder systems, the reference number 104 is used without a distinguishing letter.

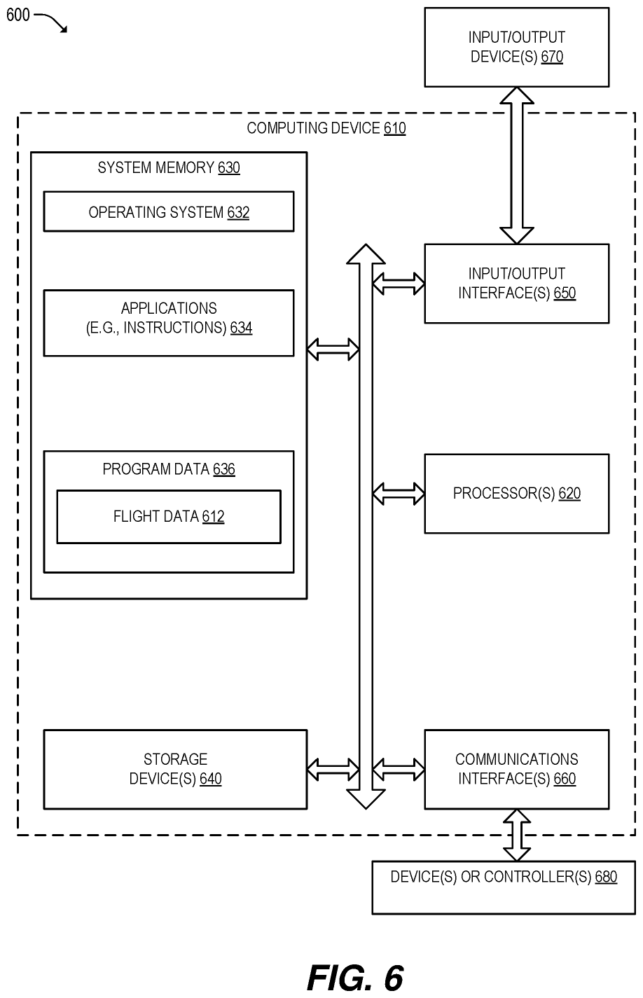

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 6 depicts a computing device 610 including one or more processors (“processor(s)” 620 in FIG. 6), which indicates that in some implementations the computing device 610 includes a single processor 620 and in other implementations the computing device 610 includes multiple processors 620. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1 depicts an example of a system 100 that includes an aircraft 102 and a plurality of deployable data recorder systems 104. The plurality of deployable data recorders systems 104 are located at several locations on the aircraft 102. FIG. 1 depicts four deployable data recorder systems 104A-D on a first side of the aircraft 102. In other implementations, the first side of the aircraft 102, and a second side of the aircraft 102, can have fewer than four deployable data recorder systems 104, or more than four deployable data recorder systems 104. Having several deployable data recorder systems 104 at different locations on the aircraft 102 greatly increases chances of recovery of one or more deployable data recorders should the aircraft 102 end up in water 130.

The deployable data recorder systems 104 include a compartment covered by a panel and a deployable data recorder 132 in the compartment. The panels enable water 130 to enter the compartments if the aircraft 102 is located in water 130. When the aircraft 102 is located in water 130, pressure of the water 130 above a threshold pressure causes deployment of a deployable data recorder system 104. Deployment causes separation of the deployable data recorder 132 from the aircraft 102. Deployment of a deployable data recorder system 104 causes inflation of inflatable bags 116, which applies force to the panel and the aircraft 102 that causes the panel to rupture or separate from the aircraft 102 and causes the deployable data recorder 132 to exit the compartment.

In the example illustrated in FIG. 1, the aircraft 102 is partially submerged in the water 130. The deployable data recorder system 104A deploys to separate a deployable data recorder 132 from the aircraft 102. When the deployable data recorder 132 separates from the aircraft 102, the deployable data recorder 132 rises to a surface 134 of the water 130 due to buoyancy of the deployable data recorder 132.

The deployable data recorder 132 includes a body 106, connector assemblies 112, and inflatable bags 116 coupled to the body 106 by the connector assemblies 112. In the implementation depicted in FIG. 1, three inflatable bags 116A-C are coupled to the body 106, but in other implementations, a different number (e.g., 2, 4, 5, or some other number) of inflatable bags 116 are coupled to the body 106.

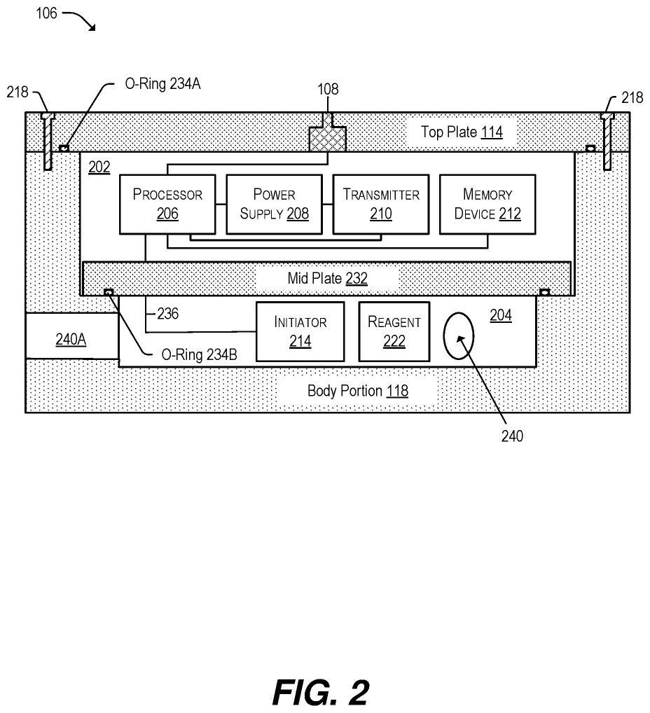

The body includes a top plate 114 and a body portion 118. In some implementations, the body 106 comprises a high-density polyethylene material that enables the body 106 to have a positive buoyancy to enable floatation of the body 106. The body 106 is configured to be water resistant to a depth that is greater (e.g., more than 3 meters greater) than a threshold depth (e.g., 4±1 meters, 10 meters, 15 meters or more). In other implementations, the body 106 comprises of low-density polyethylene (LDPE), cross-linked polyethylene (PEX), acrylonitrile butadiene styrene (ABS), polypropylene (PP), rubber-modified PP, aluminum or an aluminum alloy, other material, or a combination thereof. The body 106 includes an electronics chamber and an inflation chamber, which are described in more detail below with reference to FIG. 2. The electronics chamber includes one or more electrical components. For example, the electronics chamber includes a processor, a power supply, a transmitter, a memory device, or a combination thereof. The electronics chamber is configured to be water resistant. The inflation chamber includes at least one reagent configured to react when activated by a signal from the processor to generate a gas to inflate the inflatable bags 116. An amount of the at least one reagent causes generation of gas sufficient to inflate the inflatable bags 116 without causing rupture of the inflatable bags due to over pressurization.

A pressure sensor 108 is coupled to the body 106. The pressure sensor 108 is configured to generate pressure data and send the pressure data to the processor. In response to receiving the pressure data, the processor is configured to determine whether the deployable data recorder 132 is submerged in the water 130. When the processor determines that the deployable data recorder 132 is submerged in the water 130 below a threshold depth (e.g., 4±1 meters, 10 meters, 15 meters or more), the processor sends the signal to cause initiation of gas generation in the inflation chamber. In some implementations, the determination that the deployable data recorder 132 is submerged in the water 130 at or below the threshold depth is with a certainty of ten sigma. After sending the signal, the processor may turn off the pressure sensor 108 (e.g., send a signal to the power supply to discontinue sending power to the pressure sensor) to avoid unneeded power loss due to processing pressure data.

In some implementations, the body 106 includes a releasable connector 110. The releasable connector 110 is configured to reside in a recess of the top plate 114. The releasable connector 110 is electrically coupled to the processor. The releasable connector 110 is also configured to be releasably coupled to a data connection of the aircraft 102 before initiation of gas generation in the inflation chamber. In one aspect, the releasable connector 110 is configured to magnetically couple to a releasable connector plug of the aircraft 102. The coupling of the connectors enables the processor to couple to a data system of the aircraft 102 to receive flight data associated with the aircraft. For example, the flight data includes recorded data sent to and received from various electronic systems on the aircraft 102, cockpit conversations and other sounds in the aircraft cockpit, as well as radio communications between personnel in the cockpit and others, or both. In response to receiving the flight data, the processor is configured to store the flight data in the memory device.

In other implementations, the aircraft 102 transmits a short-range broadcast of data to be stored by the deployable data recorder 132 of the deployable data recorder systems 104. A receiver in the body 106 receives the broadcast of the data and the processor causes the data to be saved in the memory device. When pressure data received from the processor indicates to deploy the deployable data recorder 132, the receiver is powered down to prevent power loss due to use of the receiver.

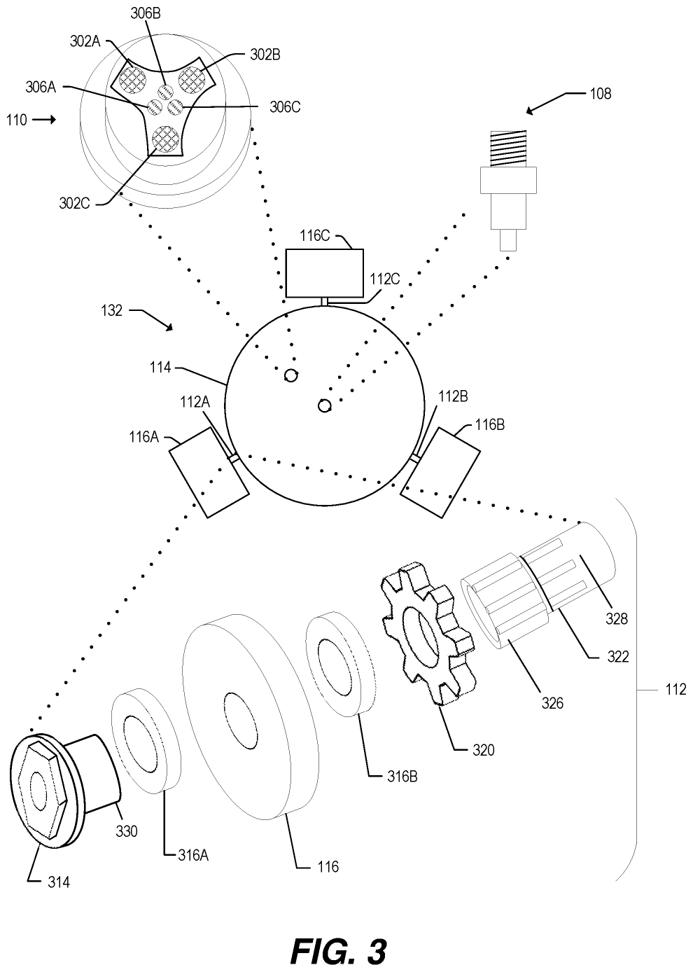

The deployable data recorder 132 includes a plurality of connector assemblies 112 coupled to the inflation chamber and the inflatable bags 116. The connector assemblies 112 function as valves that direct gas generated in the inflation chamber to the inflatable bags 116. In some implementations, a connector assembly 112 includes a one-way valve that inhibits fluid flow (e.g., water) into the inflation chamber after inflation of the inflatable bags 116 if the inflatable bag 116 should rupture (e.g., a rupture due to debris in the water 130 or failure of a seam of the inflatable bag 116). The connector assemblies 112 are described in more detail in FIG. 3.

Each of the inflatable bags 116, are coupled to individual ones of the connector assemblies 112. The inflatable bags 116 have a vibrant color to facilitate visual detection of the deployable data recorder 132. For example, vibrant colors may include red, orange, yellow, green, cyan, magenta, glow in the dark paint, or a combination thereof. The vibrant color enables a search crew aboard a vehicle (e.g., a helicopter, aircraft, or ship) to visually detect the deployable data recorder 132 from a distance. In some implementations one or more reflective bands are coupled to the inflatable bags 116. The one or more reflective bands are configured to be constructed of highly visible material to enable the search crew aboard the vehicle to visually detect the deployable data recorder 132. The inflatable bags 116 may comprise a material such as a polyvinyl chloride material. In some implementations, the material may be bamboo, paper-based materials, wool felt, polypropylene, polyethylene terephthalate (PET), polylactic acid (PLA), cellulose acetate bioplastic, ethylene-vinyl acetate (EVA), styrene-butadiene rubber (SBR), other polymeric material, or a combination thereof.

The deployable data recorder 132 includes the transmitter located within the electronics chamber of the body 106. The transmitter is configured to send a data transmission 122 to one or more receivers 126 (e.g., satellites, a receiver on a search vehicle, etc.) to facilitate location of the deployable data recorder 132 based on the data transmission 122. In some implementations, the data transmission 122 includes location information, such as a location signal, for the deployable data recorder 132. In other implementations, a strength of the data transmission 122, triangulation, other location techniques, or combinations thereof, are used to determine the location of the deployable data recorder 132 based on received data transmissions 122. Location data for the deployable data recorder 132 is provided to one or more search crews assigned to find the deployable data recorder 132.

FIG. 2 depicts a cross-sectional, block diagram representation of a body 106 of a deployable data recorder 132. The body includes the top plate 114, the body portion 118, and a mid plate 232. The mid plate 232 separates an electronic chamber 202 from an inflation chamber 204. The electronics chamber 202 includes a processor 206, a power supply 208, a transmitter 210, a memory device 212, or a combination thereof. The electronics chamber 202 is configured to be water resistant to a depth that is greater (e.g., more than 3 meters greater) than the threshold depth.

The processor 206 is configured to execute one or more stored instructions. For example, the processor 206 is configured to detect submersion of the body 106 in water. For example, the pressure sensor 108 is configured to generate pressure data and send the pressure data to the processor 206. In response to receiving the pressure data, the processor 206 determines whether the deployable data recorder 132 (i.e., the body 106) is submerged in water below the threshold depth. In response to the deployable data recorder 132 being at or below the threshold depth, the processor 206 sends a signal to an initiator 214 in the inflation chamber 204. In some implementations, the pressure sensor 108 is configured to generate an analog pressure reading. The pressure sensor 108 converts the analog pressure reading to a digital signal, and the pressure sensor 108, based on the digital signal, sends a signal to the processor 206 indicating whether the deployable data recorder 132 is at or below the threshold depth.

In an implementation, a lead 236 passes through the mid plate 232 to the initiator 214. A passage of the lead 236 through the mid plate 232 is sealed (e.g., water resistant to a depth of 20 meters or more) to prevent water from entering the electronic chamber 202 if the inflation chamber floods. In the implementation, the initiator 214 is a resistor positioned in the reagent 222. The signal causes the initiator 214 to heat above a temperature sufficient to cause a decomposition reaction of the reagent 222 to produce gas. The reagent 222 can include guanidine nitrate and the decomposition reaction generates nitrogen and steam. In some implementations, the inflation chamber 204 can include one or more canisters of gas. A spring is loaded behind that canister and the initiator 214 includes nichrome wire. When the initiator 214 receives the signal, the nichrome wire is engaged and releases the spring that launches the canister into a needle. The needle punctures the canister and gas released from the canister inflates the plurality of inflatable bags.

The mid plate 232 includes a plurality of mount openings (e.g., 8 mount openings or some other number of mount openings) and one or more recesses for O-rings. Fasteners positioned in the mount openings and corresponding mount openings in the body portion 118 couple the mid plate 232 to the body portion 118, and an O-ring 234B in a recess forms a water resistant seal between the inflation chamber 204 and the electronic chamber 202.

The inflation chamber 204 includes openings 240 configured to receive swivel valves of connector assemblies of the plurality of connector assemblies. The swivel valves may be coupled to the body 106 by threaded connections, adhesive, vibrational welding, interference fits, or a combination thereof.

The processor 206 may comprise one or more cores. The processor 206 may include general purpose microprocessors, microcontrollers, application-specific integrated circuits (ASICs), digital signal processors (DSPs), and so forth. One or more clocks may provide information indicative of date, time, ticks, and so forth. For example, the processor 206 may use data from the clock to associate a particular interaction, such as receipt of the flight data or deployment of the deployable data recorder 132, with a particular point in time.

The power supply 208 is configured to provide electrical power to the components of the deployable data recorder 132. The power supply 208 may include or correspond to batteries, capacitors, fuel cells, photovoltaic cells, wireless power receivers, conductive couplings suitable for attachment to an external power source such as provided by an electric utility, and so forth. The battery of the power supply 208 on board the deployable data recorder 132 may be charged wirelessly, such as through inductive or capacitive power transfer. In another implementation, electrical contacts may be used to recharge the batteries of the deployable data recorder 132. When the deployable data recorder 132 is on the aircraft 102, the power provided by the power supply 208 is provided via a power system of the aircraft 102. When the deployable data recorder 132 is deployed, the power supply 208 is able to provide power to operate the deployable data recorder 132 for a significant amount of time (e.g., 72 hours, 5 days, 1 week, two weeks, or some other amount of time). In some implementations, the power supply 208 is configured to be a voltage management and distribution circuit, which is coupled to the processor 206 and an auxiliary power source. The auxiliary power source may include or correspond to batteries, capacitors, fuel cells, photovoltaic cells, wireless power receivers, conductive couplings suitable for attachment to an external power source such as provided by an electric utility, and so forth. In other implementations, the power supply 208 is configured to receive instructions from the processor 206 to control an analog control loop that is configured to power the one or more components of the deployable data recorder 132.

The transmitter 210 is configured to broadcast the data transmission 122 to one or more receivers (e.g., satellites or receivers associated with search vehicles), as described in FIG. 1. In some implementations, the transmitter 210 is configured to transmit the data transmission 122 as a location signal at different frequencies, modulation, phase, output power levels, time intervals, or a combination thereof, based a passage of time or receipt of a response signal. For example, the transmitter 210 can be configured to send the data transmission 122 at a first power level every thirty (30) seconds for a first period of 24 hours after deployment, at a second power level every sixty (60) seconds after the first period of 24 hours for a second period of 24 hours, and at a third power level every ninety (90) seconds after the first and second 24 hour periods for another a third period of 24 hours. In another example, the transmitter 210 is configured to send the data transmission 122 at a particular time interval, where each time interval is associated with sending the data transmission 122 at a particular frequency and power output level.

The memory device 212 can include one or more non-transitory, computer-readable storage media (CRSM). The CRSM can be any one or more of an electronic storage medium, a magnetic storage medium, an optical storage medium, a quantum storage medium, a mechanical computer storage medium, and so forth. The memory device 212 stores aircraft data received from the aircraft 102 during operation of the aircraft 102. The memory device 212 is sized to store at least 120 hours of operation data for the aircraft 102. When the memory device 212 is filled with operation data of the aircraft 102, new operation data for the aircraft 102 overwrites the oldest operation data of the aircraft 102.

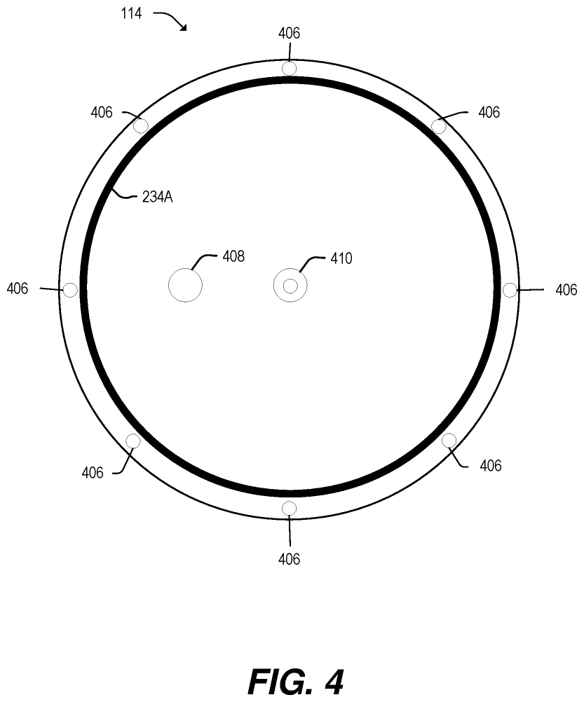

The body 106 includes the top plate 114, which is described in more detail below with reference to FIG. 4. The top plate 114 includes a plurality of mount openings (e.g., 8 mount openings or some other number of mount openings) and one or more recesses. Fasteners 218 positioned in the mount openings and corresponding mount openings in the body portion couple the top plate 114 to the body portion 118, and an O-ring 234A in a recess in the top plate 114 forms a water resistant seal between an outside environment and the electronics chamber 202.

As illustrated in FIG. 2, the fasteners 218 pass through mount openings in the top plate 114 and into corresponding mount openings in the body portion 118. In some implementations, the top plate 114 can be affixed to the body 106 using interference fits, fasteners 218, adhesives, welding, other types of connections, or combinations thereof. The affixation of the top plate 114 to the body 106 can be reversible or irreversible. For example, the fasteners 218 (e.g., screws) can be designed to allow for the insertion or removal of the fasteners 218, while an interference fit may include a tab that cannot be released once it has been engaged. In another example, an interference fit features may include tabs, grooves, ridges, latches, and so forth.

A technical advantage of the deployable data recorder 132, as illustrated in FIG. 2 includes the deployable data recorder 132 staying afloat even when one or more of the plurality of inflatable bags 116 fails or fills with water and having an electronics chamber 202 that is water resistant, so as to protect the flight data stored in the memory device 212.

FIG. 3 is a particular implementation that illustrates the deployable data recorder 132 and one or more components included with the deployable data recorder 132. The deployable data recorder 132 includes the top plate 114 and the inflatable bags 116 and described in FIGS. 1 and 2. As illustrated in FIG. 3, the deployable data recorder 132 is shown in an undeployed state. The inflatable bags 116 are shown rolled up and held in an undeployed configuration by tape, one or more breakable binding straps, or other types of connectors that hold the inflatable bags in the undeployed configuration.

The deployable data recorder 132 includes the releasable connector 110. The releasable connector 110 is configured to reside in a recess of the top plate 114 of the body 106. The releasable connector 110 is electrically coupled to the processor. The releasable connector 110 is also configured to be releasably coupled to a data connection of the aircraft 102 before initiation of the reaction in the inflation chamber. In one aspect, the releasable connector 110 is configured to magnetically couple to a releasable connector plug of the aircraft 102. The releasable connector 110 is configured to couple to the releasable connector plug via one or more magnets 302A-C coupling to a corresponding one or more magnets located on the releasable connector plug. In some implementations, the number of magnets 302 used can be fewer than three or more than three. The coupling of the connectors enables the processor to couple to a data system of the aircraft 102 to receive flight data associated with the aircraft. Receiving the flight data occurs when one or more pins 306A-C of the releasable connector 110 is coupled with a corresponding one or more pins of the releasable connector plug. For example, the flight data includes recorded data sent to and received from various electronic systems on the aircraft 102, cockpit conversations and other sounds in the aircraft cockpit, as well as radio communications between personnel in the cockpit and others, or both. In response to receiving the flight data, the processor is configured to store the flight data in the memory device 212. In some implementations, the number of pins 306 used can be fewer than three or more than three.

The deployable data recorder 132 includes the pressure sensor 108. The pressure sensor 108 is mounted in a recess in the top plate 114 of the body 106 to form a water resistant connection at least to a depth of 20 meters or more. The pressure sensor 108 provides pressure data to the processor 206. A suitable pressure sensor is available from DigiKey (Thief River Falls, MN).

The connector assemblies 112A-C include one or more components to couple each of the inflatable bags 116A-C to the body 106. The one or more components include a bulkhead valve 314, rubber gaskets 316A, 316B, a valve fitting 320, a swivel valve 322, or a combination thereof. The bulkhead valve 314 is configured to create a seal to avoid leakage of gas from the inflated inflatable bag 116 and to prevent water from entering the inflatable bag 116, the inflation chamber 204, or both. The rubber gaskets 316A, 316B are configured to prevent damage to the inflatable bag 116, to evenly distribute the load of the bulkhead valve 314, and the swivel valve 322, absorb vibrations, enable a secure connection of the inflatable bags 116 to the body 106, and the like. One or both of the rubber gaskets 316 may be irreversible coupled to the inflatable bag 116.

The swivel valve 322 is configured to mate with the valve fitting 320. The swivel valve 322 includes a tool head 326 that is configured to be rotatable relative to a central body 328 of the swivel valve 322 without rotation of the central body to enable the swivel valve 322 to be coupled or uncoupled from a connection end 330 of the bulkhead valve 314. Rotation of the tool head 326 relative to the central body 328 without rotation of the central body 328 allows the inflatable bag 116 to be coupled or uncoupled to the body 106 without rotation of the body 106 or the inflatable bag 116. In some implementations, the connector assemblies 112 can include a one-way valve configured to inhibit fluid flow into the inflation chamber 204 after inflation of the inflatable bags 116. The one-way valve can also be part of the swivel valve 322 that enables separation of the inflatable bag 116 from the body 106 without rotation of the body 106, the inflatable bag 116, or both.

A technical advantage of the deployable data recorder 132, as illustrated in FIG. 3 includes a connector assembly 112 that enables separation of the inflatable bags 116 from the body 106 without rotation of the body 106, the inflatable bags 116, or both.

FIG. 4 is a diagram that illustrates the top plate 114 of the deployable data recorder 132. The top plate 114 is configured to have the O-ring 234A that is positioned in a groove formed in the top plate 114. The O-ring 234A forms a water resistant seal between the electronics chamber 202 and the water 130.

The top plate 114 includes a plurality of mounting holes 406. Fasteners positioned in the mounting holes couple the top plate 114 to the body portion 118 of the body 106. In some implementations, the top plate 114 can be affixed to the body 106 using one or more interference fits, fasteners 218, adhesives, welding, and so forth. The affixation of the top plate 114 to the body 106 can be reversible or not. For example, the fastener 218 can be designed to allow for the insertion or removal of the fastener 218 through individual ones of the plurality of mounting holes 406, while a mechanical interference fit may include a tab that cannot be released once it has been engaged. In another example, mechanical interference fit features may include tabs, grooves, ridges, latches, and so forth. It is understood that these various techniques to fix the top plate 114 to the body 106 can be used in various combinations with one another.

The top plate 114 further includes a recess 410 configured to receive the pressure sensor 108. The top plate 114 also includes a recess 408 configured to receive the releasable connector 110.

A technical advantage of the top plate 114, as illustrated in FIG. 4, includes creating a water resistant seal between the top plate 114 and the body 106 such that water is unable to enter the electronics chamber 202.

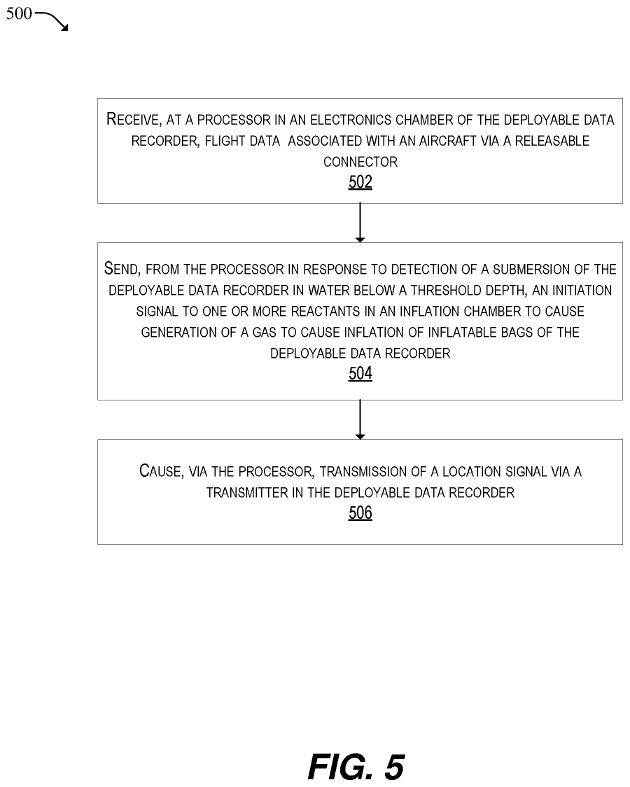

FIG. 5 is a flow chart of a method 500 of use of a deployable data recorder system 104. The method 500 includes, at block 502, receiving, at a processor 206 in an electronics chamber 202 of the deployable data recorder 132 of the deployable data recorder system 104, flight data associated with an aircraft 102 via a releasable connector. For example, the body 106 includes a releasable connector 110. The releasable connector 110 is configured to reside in a recess of the top plate 114 of the body 106. The releasable connector 110 is electrically coupled to the processor 206. The releasable connector 110 is also configured to be releasably coupled to a data connection of the aircraft 102 before initiation of the reaction in the inflation chamber 204. In one aspect, the releasable connector 110 is configured to magnetically couple to a releasable connector plug of the aircraft 102. The coupling of the connectors enables the processor 206 to couple to a data system of the aircraft 102 to receive flight data associated with the aircraft 102. For example, the flight data includes recorded data sent to and received from various electronic systems on the aircraft 102, cockpit conversations and other sounds in the aircraft cockpit, as well as radio communications between personnel in the cockpit and others, or both. In response to receiving the flight data, the processor 206 is configured to store the flight data in the memory device 212. In some implementations, the flight data is encrypted.

The method 500 includes, at block 504, sending, from the processor 206 in response to detection of a submersion of the deployable data recorder 132 in water below a threshold depth, an initiation signal to one or more reactants in an inflation chamber 204 to cause generation of a gas to cause inflation of inflatable bags 116 of the deployable data recorder 132. For example, the pressure sensor 108 is coupled to the top plate 114 of the body 106. The pressure sensor 108 is configured to generate pressure data and send the pressure data to the processor 206. In response to receiving the pressure data, the processor 206 is configured to determine whether the deployable data recorder 132 is submerged in water based on the pressure data. When the processor determines that the deployable data recorder 132 is submerged in water below the threshold depth, the processor 206 sends a signal to an initiator 214 via a lead 236 to cause initiation of a reaction in the inflation chamber 204.

Initiation of the reaction causes generation of gas that inflates the inflatable bags 116. Inflation of the inflatable bags 116 causes force to be applied to a panel of the deployable data recorder system 104 and the aircraft 102 that causes rupture or removal of the panel and separation of the deployable data recorder 132 from the aircraft 102 into surrounding water 130. Buoyancy provided by the body 106, gas in the inflatable bags 116, or both, causes the deployable data recorder 132 to rise to a surface 134 of the water 130.

The method 500 includes, at block 506, causing, via the processor 206, transmission of a data transmission 122 via a transmitter 210 in the deployable data recorder 132. For example, the deployable data recorder 132 includes the transmitter 210 located within the electronics chamber 202 of the body 106. The transmitter 210 is configured to send the data transmission 122 to one or more receivers. The one or more receivers, upon receipt of the data transmission 122, determine and send location data to one or more search crews to begin searching for the deployable data recorder 132.

FIG. 6 is a block diagram of a computing environment 600 including a computing device 610 configured to support aspects of computer-implemented methods and computer-executable program instructions (or code) according to the present disclosure. For example, the computing device 610, or portions thereof, is configured to execute instructions to initiate, perform, or control one or more operations described with reference to FIGS. 1-5.

The computing device 610 includes one or more processors 620. The processor(s) 620 are configured to communicate with system memory 630, one or more storage devices 640, one or more input/output interfaces 650, one or more communications interfaces 660, or any combination thereof. The system memory 630 includes volatile memory devices (e.g., random access memory (RAM) devices), nonvolatile memory devices (e.g., read-only memory (ROM) devices, programmable read-only memory, and flash memory), or both. The system memory 630 stores an operating system 632, which may include a basic input/output system for booting the computing device 610 as well as a full operating system to enable the computing device 610 to interact with users, other programs, and other devices. The system memory 630 stores system (program) data 636, such as flight data 612.

The system memory 630 includes one or more applications 634 (e.g., sets of instructions) executable by the processor(s) 620. As an example, the one or more applications 634 include instructions executable by the processor(s) 620 to initiate, control, or perform one or more operations described with reference to FIGS. 1-5.

In a particular implementation, the system memory 630 includes a non-transitory, computer-readable medium storing the instructions that, when executed by the processor(s) 620, cause the processor(s) 620 to initiate, perform, or control operations to aid in design of an object. The operations include receiving flight data associated with an aircraft via a releasable connector; sending an initiation signal to one or more reactants in an inflation chamber to cause generation of a gas to cause inflation of a plurality of inflatable bags of the deployable data recorder; and causing transmission of a data transmission 122 via a transmitter in the deployable data recorder.

The one or more storage devices 640 include nonvolatile storage devices, such as magnetic disks, optical disks, or flash memory devices. In a particular example, the storage devices 640 include both removable and non-removable memory devices. The storage devices 640 are configured to store an operating system, images of operating systems, applications (e.g., one or more of the applications 634), and program data (e.g., the program data 636). In a particular aspect, the system memory 630, the storage devices 640, or both, include tangible computer-readable media. In a particular aspect, one or more of the storage devices 640 are external to the computing device 610.

The one or more input/output interfaces 650 enable the computing device 610 to communicate with one or more input/output devices 670 to facilitate user interaction. For example, the one or more input/output interfaces 650 can include a display interface, an input interface, or both. For example, the input/output interface 650 is adapted to receive input from a user, to receive input from another computing device, or a combination thereof. In some implementations, the input/output interface 650 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 670 includes one or more user interface devices and displays, including some combination of buttons, keyboards, pointing devices, displays, speakers, microphones, touch screens, and other devices.

The processor(s) 620 are configured to communicate with devices or controllers 680 via the one or more communications interfaces 660. For example, the one or more communications interfaces 660 can include a network interface.

In some implementations, a non-transitory, computer-readable medium stores instructions that, when executed by one or more processors, cause the one or more processors to initiate, perform, or control operations to perform part or all of the functionality described above. For example, the instructions may be executable to implement one or more of the operations or methods of FIGS. 1-6. In some implementations, part, or all of one or more of the operations or methods of FIGS. 1-6 may be implemented by one or more processors (e.g., one or more central processing units (CPUs), one or more graphics processing units (GPUs), one or more digital signal processors (DSPs)) executing instructions, by dedicated hardware circuitry, or any combination thereof.

Particular aspects of the disclosure are described below in sets of interrelated Examples:

According to Example 1, an apparatus, includes a body, wherein the body includes an electronics chamber and an inflation chamber; a pressure sensor coupled to the body; a plurality of connector assemblies coupled to the inflation chamber; inflatable bags, wherein each inflatable bag is coupled to an individual connector assembly of the plurality of connector assemblies; a transmitter located within the electronics chamber; a processor located within the electronics chamber and coupled to a memory device, wherein the processor is configured to detect submersion of the body in water; send a signal to cause initiation of a reaction in the inflation chamber; and cause the transmitter to send a data transmission.

Example 2 includes the apparatus of Example 1, further comprising a releasable connector disposed in a recess of the body, wherein the releasable connector is electrically coupled to the processor, and wherein the releasable connector is configured to be releasably coupled to a data connection of an aircraft before initiation of the reaction.

Example 3 includes the apparatus of Example 2, wherein the releasable connector is configured to magnetically couple to a corresponding releasable connector of the aircraft.

Example 4 includes the apparatus of Example 2 or Example 3, wherein the releasable connector is configured to couple the processor to a data system of the aircraft to receive flight data associated with the aircraft.

Example 5 includes the apparatus of Example 4, wherein the processor is further configured to store the flight data in the memory device.

Example 6 includes the apparatus of any of Examples 1 to 5, wherein the body comprises a high-density polyethylene material, and wherein the body has a positive buoyancy configured to enable floatation of the body.

Example 7 includes the apparatus of any of Examples 1 to 6, wherein the electronics chamber is configured to be water resistant.

Example 8 includes the apparatus of any of Examples 1 to 7, wherein the inflatable bags have a vibrant color to facilitate visual detection of the apparatus.

Example 9 includes the apparatus of Example 8, wherein the inflatable bags comprises a polyvinyl chloride material.

Example 10 includes the apparatus of any of Examples 1 to 9, wherein the reaction in the inflation chamber generates a gas to inflate the inflatable bags.

Example 11 includes the apparatus of any of Examples 1 to 10, wherein a connector assembly of the plurality of connector assemblies includes a valve coupled to an inflatable bag.

Example 12 includes the apparatus of any of Examples 1 to 11, wherein the valve is a one-way valve configured to inhibit fluid flow into the inflation chamber after inflation of the inflatable bags.

Example 13 includes the apparatus of any of Examples 1 to 12, wherein the body further comprises an opening configured to receive a connector assembly of the plurality of connector assemblies, wherein the connection is configured to couple to an inflatable bag of the inflatable bags and the body, and wherein the connection enables separation of the inflatable bag from the body without rotation of the body, the inflatable bag, or both.

Example 14 includes the apparatus of any of Examples 1 to 13, wherein the body further comprises a top plate, and wherein the cover comprises: a first recess configured to receive the pressure sensor; a second recess configured to receive a releasable connector configured to provide aircraft data to the memory device; a groove configured to receive an O-ring; and one or more openings configured to receive one or more fasteners to join the top plate to the body.

According to Example 15, a system includes a plurality of deployable data recorder systems on an aircraft, wherein each of the plurality of deployable data recorder systems is located at a different location on the aircraft, and wherein each of the plurality of deployable data recorder systems comprises: a body, wherein the body includes an electronics chamber and an inflation chamber; a pressure sensor coupled to the body; a plurality of connector assemblies coupled to the inflation chamber; inflatable bags, wherein each inflatable bag is coupled to an individual connector assemblies of the plurality of connector assemblies; a transmitter located within the electronics chamber; a processor located within the electronics chamber and coupled to a memory device, wherein the processor is configured to detect submersion of the body in water; send a signal to cause initiation of a reaction in the inflation chamber to generate gas to cause inflation of the inflatable bags; and cause the transmitter to send a data transmission.

Example 16 includes the system of Example 15, wherein each of the plurality of deployable data recorder systems further comprises a releasable connector configured to couple the processor to a data system of the aircraft to receive flight data associated with the aircraft for storage in the memory device.

Example 17 includes the system of Example 15 or Example 16, wherein the releasable connector is magnetic and further comprises one or more pins to enable the processor to receive the flight data associated with the aircraft from the data system.

Example 18 includes the system of any of Examples 15 to 17, wherein a connector assembly of the plurality of connector assemblies coupled to an inflatable bag of the inflatable bags and the inflation chamber includes a one-way valve configured to inhibit fluid flow into the inflation chamber after inflation of the inflatable bags.

Example 19 includes the system of any of Examples 15 to 18, wherein the body is buoyant.

According to Example 20, a method of use of a deployable data recorder, the method includes receiving, at a processor in an electronics chamber of the deployable data recorder, flight data associated with an aircraft via a releasable connector; sending, from the processor in response to detection of a submersion of the deployable data recorder in water, an initiation signal to one or more reactants in an inflation chamber to cause generation of a gas to cause inflation of inflatable bags of the deployable data recorder; and causing, via the processor, transmission of a data transmission via a transmitter in the deployable data recorder.

Example 21 includes the method of Example 20, wherein inflation of the plurality of inflatable bags is configured to cause separation of the deployable data recorder from the releasable connector and separation of the deployable data recorder from the aircraft.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. An apparatus, comprising:
a body, wherein the body includes an electronics chamber and an inflation chamber;
a pressure sensor coupled to the body;
a plurality of connector assemblies coupled to the inflation chamber;
inflatable bags, wherein each inflatable bag is coupled to an individual connector assembly of the plurality of connector assemblies;
a transmitter located within the electronics chamber; and
a processor located within the electronics chamber and coupled to a memory device, wherein the processor is configured to:
detect submersion of the body in water;
send a signal to cause initiation of a reaction in the inflation chamber; and
cause the transmitter to send a data transmission.

2. The apparatus of claim 1, further comprising a releasable connector disposed in a recess of the body, wherein the releasable connector is electrically coupled to the processor, and wherein the releasable connector is configured to be releasably coupled to a data connection of an aircraft before initiation of the reaction.

3. The apparatus of claim 2, wherein the releasable connector is configured to magnetically couple to a corresponding releasable connector of the aircraft.

4. The apparatus of claim 2, wherein the releasable connector is configured to couple the processor to a data system of the aircraft to receive flight data associated with the aircraft.

5. The apparatus of claim 4, wherein the processor is further configured to store the flight data in the memory device.

6. The apparatus of claim 1, wherein the body comprises a high-density polyethylene material, and wherein the body has a positive buoyancy configured to enable floatation of the body.

7. The apparatus of claim 1, wherein the electronics chamber is configured to be water resistant.

8. The apparatus of claim 1, wherein the inflatable bags have a vibrant color to facilitate visual detection of the apparatus.

9. The apparatus of claim 8, wherein the inflatable bags comprises a polyvinyl chloride material.

10. The apparatus of claim 1, wherein the reaction in the inflation chamber generates a gas to inflate the inflatable bags.

11. The apparatus of claim 1, wherein a connector assembly of the plurality of connector assemblies includes a valve coupled to an inflatable bag.

12. The apparatus of claim 11, wherein the valve is a one-way valve configured to inhibit fluid flow into the inflation chamber after inflation of the inflatable bags.

13. The apparatus of claim 1, wherein the body further comprises an opening configured to receive a connector assembly of the plurality of connector assemblies, wherein the connector assembly is configured to couple to an inflatable bag of the inflatable bags and the body, and wherein the connector assembly enables separation of the inflatable bag from the body without rotation of the body, the inflatable bag, or both.

14. The apparatus of claim 1, wherein the body further comprises a top plate, and wherein the top plate comprises:
a first recess configured to receive the pressure sensor;
a second recess configured to receive a releasable connector configured to provide aircraft data to the memory device;
a groove configured to receive an O-ring; and
one or more openings configured to receive one or more fasteners to join the top plate to the body.

15. A system comprising:
a plurality of deployable data recorder systems on an aircraft, wherein each of the plurality of deployable data recorder systems is located at a different location on the aircraft, and wherein each of the plurality of deployable data recorder systems comprises:
a body, wherein the body includes an electronics chamber and an inflation chamber;
a pressure sensor coupled to the body;
a plurality of connector assemblies coupled to the inflation chamber;
inflatable bags, wherein each inflatable bag is coupled to an individual connector assembly of the plurality of connector assemblies;
a transmitter located within the electronics chamber;
a processor located within the electronics chamber and coupled to a memory device, wherein the processor is configured to:
detect submersion of the body in water;
send a signal to cause initiation of a reaction in the inflation chamber to generate gas to cause inflation of the inflatable bags; and
cause the transmitter to send a data transmission.

16. The system of claim 15, wherein each of the plurality of deployable data recorder systems further comprises a releasable connector configured to couple the processor to a data system of the aircraft to receive flight data associated with the aircraft for storage in the memory device.

17. The system of claim 16, wherein the releasable connector is magnetic and further comprises one or more pins to enable the processor to receive the flight data associated with the aircraft from the data system.

18. The system of claim 15, wherein a connector assembly of the plurality of connector assemblies coupled to an inflatable bag of the inflatable bags and the inflation chamber includes a one-way valve configured to inhibit fluid flow into the inflation chamber after inflation of the inflatable bags.

19. The system of claim 15, wherein the body is buoyant.

20. A method of use of a deployable data recorder, the method comprising:
receiving, at a processor in an electronics chamber of the deployable data recorder, flight data associated with an aircraft via a releasable connector;
sending, from the processor in response to detection of a submersion of the deployable data recorder in water, an initiation signal to one or more reactants in an inflation chamber to cause generation of a gas to cause inflation of inflatable bags of the deployable data recorder; and
causing, via the processor, transmission of a data transmission via a transmitter in the deployable data recorder.

21. The method of claim 20, wherein inflation of the inflatable bags is configured to cause separation of the deployable data recorder from the releasable connector and separation of the deployable data recorder from the aircraft.
